(19) United States
(12) Patent Application Publication
(10) Pub. No.: US 2026/0304167 A1
(43) Pub. Date: Oct. 1, 2026

(54) WIRELESS MEASUREMENT APPARATUS AND WIRELESS MEASUREMENT METHOD

(71) Applicant: ANRITSU CORPORATION, Kanagawa (JP)

(72) Inventors: Hirofumi KANNO, Kanagawa (JP); Yoshiya SHIKAMA, Kanagawa (JP)

(21) Appl. No.: 19/561,630

(22) Filed: Mar. 10, 2026

(30) Foreign Application Priority Data
Mar. 27, 2025 (JP) 2025-053833

(51) Int. Cl. H04W 24/06; H04W 72/0453; H04W 84/12

(52) U.S. Cl. CPC H04W 24/06; H04W 72/0453; H04W 84/12

(57) ABSTRACT

A wireless measurement apparatus includes a signal generator including a first frequency conversion unit and a signal analyzer including a second frequency conversion unit, in which the wireless measurement apparatus transmits a signal generated by the signal generator to a device under test W, and receives and measures a signal from the device under test W by the signal analyzer in association with the transmission, and, in an oscillator of the first frequency conversion unit and an oscillator of the second frequency conversion unit, a frequency setting value of at least one of the first frequency conversion unit and the second frequency conversion unit is variable such that, at an output point P3 of the second frequency conversion unit, a frequency component of the signal from the device under test W does not overlap with IM2 or HD2 serving as unwanted waves.

### TECHNICAL FIELD

The present invention relates to a wireless measurement apparatus and a wireless measurement method for performing measurement of a device under test (DUT) using wireless communication.

### BACKGROUND ART

For example, Patent Document 1 below discloses a technique, as an invention of an integrated receiving apparatus, that eliminates the need for a filter bank in a case where a wideband signal is received, and removes an influence of an adjacent interference wave.

Meanwhile, recent communication development requires an expansion of a signal bandwidth and an expansion of a modulation order. For example, in WLAN standard IEEE 802.11be, there is a requirement for 320 MHz as the signal bandwidth and 4096 QAM as a modulation scheme, and, as the modulation order becomes higher, an error vector magnitude (EVM) requirement also becomes more stringent.

For example, in 4096 QAM of the WLAN standard IEEE 802.11be, the EVM requirement is set to -38 dB. In that case, a sufficient margin is necessary for highly reliable measurement, and a residual EVM of -53 to -55 dB is expected as performance required for a signal source and a spectrum analyzer.

### Related art Document

### Patent Document

[Patent Document 1] Japanese Patent No. 4868463

### Disclosure of the Invention

### Problem that the Invention is to Solve

As described above, in recent wireless communication apparatuses, while frequencies are diversifying, a bandwidth is becoming a wideband. In addition, in EVM measurement of a signal under measurement of multi-level modulation, since an influence of EVM generated in a wireless measurement apparatus on a measurement result increases, improvement is required.

Then, along with the diversification of the frequency of the wireless communication apparatus and the fact that the bandwidth has become a wideband, frequency components of IM2 and HD2 generated in the wireless measurement apparatus may overlap with the signal under measurement. As a result, a problem arises that EVM deteriorates, and improvement has been required.

Therefore, the present invention has been made in view of the above problem, and an object of the present invention is to provide a wireless measurement apparatus and a wireless measurement method capable of suppressing deterioration of EVM.

### Means for solving the problem

In order to achieve the above object, the wireless measurement apparatus described in Claim 1 of the present invention is a wireless measurement apparatus 1 including:

a signal generator 2 including a first frequency conversion unit 12; and

a signal analyzer 3 including a second frequency conversion unit 22,

in which the wireless measurement apparatus transmits a signal generated by the signal generator to a device under test W, and receives and measures a signal from the device under test by the signal analyzer in association with the transmission, and

the first frequency conversion unit and the second frequency conversion unit change a frequency setting value of at least one of the first frequency conversion unit and the second frequency conversion unit such that, at an output point of the second frequency conversion unit, a frequency component of the signal from the device under test does not overlap with intermodulation 2 (IM2) or harmonic distortion 2 (HD2).

The wireless measurement apparatus described in Claim 2 of the present invention is the wireless measurement apparatus according to Claim 1,

in which the first frequency conversion unit may perform up-conversion, and the second frequency conversion unit may perform down-conversion.

The wireless measurement apparatus described in Claim 3 of the present invention is the wireless measurement apparatus according to Claim 1,

in which the frequency setting value may be changed based on a channel arrangement of WLAN defined in IEEE 802.11.

The wireless measurement method described in Claim 4 of the present invention is a wireless measurement method using a wireless measurement apparatus 1 including a signal generator 2 including a first frequency conversion unit 12 and a signal analyzer 3 including a second frequency conversion unit 22, the wireless measurement method including:

a step of changing frequency setting values of the first frequency conversion unit and the second frequency conversion unit such that, at an output point of the second frequency conversion unit, a frequency component of a signal from a device under test does not overlap with intermodulation 2 (IM2) or harmonic distortion 2 (HD2).

The wireless measurement method described in Claim 5 of the present invention is the wireless measurement method according to Claim 4,

in which the first frequency conversion unit performs up-conversion, and

the second frequency conversion unit performs down-conversion.

The wireless measurement method described in Claim 6 of the present invention is the wireless measurement method according to Claim 4, in which the frequency setting values are varied based on a channel arrangement of WLAN defined in IEEE 802.11.

### Advantage of the Invention

According to the present invention, by shifting IM2 and HD2 generated on a transmission side to out-of-band on a reception side, in-band emission is prevented from deteriorating, and performance of reception-side EVM < -53 dB can be obtained.

### BRIEF DESCRIPTION OF THE DRAWINGS

FIG. 1 is a block diagram showing a schematic configuration of a wireless measurement apparatus according to the present invention.

FIG. 2 is a flowchart showing a schematic operation of a measurement method using the wireless measurement apparatus according to the present invention.

FIG. 3 is a diagram showing an example of a signal waveform at an output point P1 of a waveform generation unit of a signal generator in FIG. 1.

FIG. 4 is a diagram showing an example of a signal waveform at an output point P2 of a transmission-side frequency conversion unit of the signal generator in FIG. 1.

FIG. 5 is a diagram showing an example of a signal waveform before improvement at an output point P3 of a reception-side frequency conversion unit of a signal analyzer in FIG. 1.

FIG. 6 is a diagram showing an example of a signal waveform after improvement of the output point P3 of the reception-side frequency conversion unit of the signal analyzer in FIG. 1.

### BEST MODE FOR CARRYING OUT THE INVENTION

Hereinafter, modes for carrying out the present invention will be described in detail with reference to the accompanying drawings.

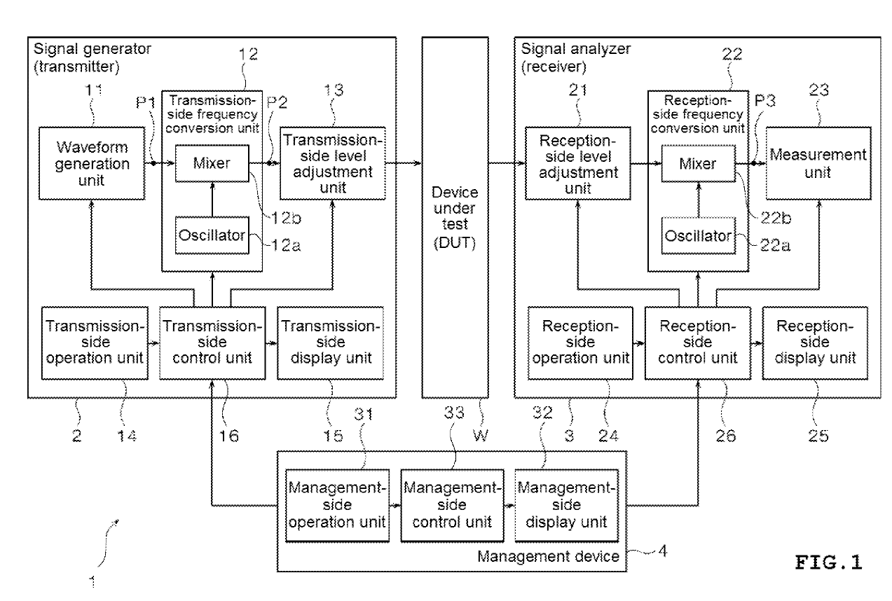

As shown in FIG. 1, a wireless measurement apparatus 1 of the present embodiment measures a device under test (DUT) W using wireless communication, and schematically includes a signal generator 2 as a transmitter, a signal analyzer 3 as a receiver, and a management device 4.

The signal generator 2 as a transmitter generates a radio frequency (RF) signal to be transmitted to the device under test W, and includes a waveform generation unit 11, a transmission-side frequency conversion unit 12, a transmission-side level adjustment unit 13, a transmission-side operation unit 14, a transmission-side display unit 15, and a transmission-side control unit 16.

Under control of the transmission-side control unit 16 based on a command from a management-side control unit 33 (described below) of the management device 4, the waveform generation unit 11 generates an intermediate frequency (IF) signal of a desired signal DA-converted into an analog signal by a DA converter, based on settings of a management-side operation unit 31 (described below) of the management device 4 (or settings of the transmission-side operation unit 14), and outputs the IF signal to the transmission-side frequency conversion unit 12.

The transmission-side frequency conversion unit 12 is a first frequency conversion unit using up-conversion, includes an oscillator 12a and a mixer 12b, frequency-converts the IF signal input from the waveform generation unit 11 into an RF signal of a high frequency under control of the transmission-side control unit 16 based on a command from the management-side control unit 33 (described below) of the management device 4, and outputs the RF signal to the transmission-side level adjustment unit 13.

Under control of the transmission-side control unit 16 based on a command from the management-side control unit 33 (described below) of the management device 4, the transmission-side level adjustment unit 13 adjusts the RF signal input from the transmission-side frequency conversion unit 12 to a desired level, based on settings of the management-side operation unit 31 (described below) of the management device 4 (or settings of the transmission-side operation unit 14), and transmits the level-adjusted RF signal to the device under test W.

Under control of the transmission-side control unit 16 based on a command from the management-side control unit 33 (described below) of the management device 4, the transmission-side operation unit 14 performs instructions to start or stop measurement of the device under test W by the wireless measurement apparatus 1, settings of a frequency or an output level of the signal generated by the waveform generation unit 11, settings of a frequency of the oscillator 12a of the transmission-side frequency conversion unit 12, settings of an output level of the signal of the transmission-side level adjustment unit 13, and the like.

Here, a frequency setting value of the oscillator 12a is set such that, at an output point P3 of a reception-side frequency conversion unit 22 of the signal analyzer 3 in FIG. 1, frequency components of intermodulation (IM) 2 and harmonic distortion (HD) 2 serving as unwanted waves do not overlap with a desired signal of the signal from the device under test W. Specifically, the frequency setting value of the oscillator 12a is determined based on a channel arrangement of WLAN defined in IEEE 802.11 which is a communication standard of Wi-Fi (registered trademark).

Note that the IM2 serving as the unwanted wave refers to two-signal second-order intermodulation distortion, and occurs at frequency positions of f2 - f1 and f2 + f1 with respect to desired signals of frequencies f1 and f2 (f1<f2). Then, a difference between frequency components of respective subcarriers of the desired signal is low-band IM2, and a sum of frequency components of respective subcarriers of the desired signal is high-band IM2.

In addition, HD2 serving as the unwanted wave refers to a harmonic having a frequency twice the frequency of a subcarrier of the desired signal.

The transmission-side display unit 15 is configured by, for example, a liquid crystal display (LCD), an organic electroluminescence display (OLED), or the like, and, under control of the transmission-side control unit 16 based on a command from the management-side control unit 33 (described below) of the management device 4, displays setting contents by the transmission-side operation unit 14, signal waveforms at respective output points P1 and P2 in FIG. 1, measurement results, and the like.

The transmission-side control unit 16 integrally controls the waveform generation unit 11, the transmission-side frequency conversion unit 12, the transmission-side level adjustment unit 13, the transmission-side operation unit 14, and the transmission-side display unit 15 based on setting contents of the management-side operation unit 31 (or setting contents of the transmission-side operation unit 14) in accordance with a command from the management-side control unit 33 (described below) of the management device 4.

When the RF signal generated by the signal generator 2 is transmitted to the device under test W, the signal analyzer 3 as a receiver analyzes an RF signal received from the device under test W in association with the transmission, and includes a reception-side level adjustment unit 21, a reception-side frequency conversion unit 22, a measurement unit 23, a reception-side operation unit 24, a reception-side display unit 25, and a reception-side control unit 26.

Under control of the reception-side control unit 26 based on a command from the management-side control unit 33 (described below) of the management device 4, the reception-side level adjustment unit 21 adjusts an RF signal including a desired signal received from the device under test W to a desired level, based on settings of the management-side operation unit 31 (described below) of the management device 4 (or settings of the reception-side operation unit 24), and outputs the level-adjusted RF signal to the reception-side frequency conversion unit 22.

The reception-side frequency conversion unit 22 is a second frequency conversion unit using down-conversion, includes an oscillator 22a and a mixer 22b, and, under control of the reception-side control unit 26 based on a command from the management-side control unit 33 (described below) of the management device 4, frequency-converts the RF signal input from the reception-side level adjustment unit 21 into an intermediate frequency (IF) signal of a low frequency, and outputs the IF signal to the measurement unit 23.

Under control of the reception-side control unit 26 based on a command from the management-side control unit 33 (described below) of the management device 4, the measurement unit 23 AD-converts the IF signal input from the reception-side frequency conversion unit 22 into a digital signal by an AD converter, and performs desired measurement including error vector magnitude (EVM) measurement based on the AD-converted digital signal.

Under control of the reception-side control unit 26 based on a command from the management-side control unit 33 (described below) of the management device 4, the reception-side operation unit 24 performs instructions to start or stop measurement of the device under test W by the wireless measurement apparatus 1, settings of an output level of the signal of the reception-side level adjustment unit 21, settings of a frequency of the oscillator 22a of the reception-side frequency conversion unit 22, and the like.

Here, similarly to the oscillator 12a of the transmission-side frequency conversion unit 12 of the signal generator 2, a frequency setting value of the oscillator 22a is set such that, at an output point P3 of the reception-side frequency conversion unit 22 of the signal analyzer 3 in FIG. 1, IM2 and HD2 serving as unwanted waves do not overlap with the desired signal of the signal from the device under test W. Specifically, the frequency setting value of the oscillator 22a is determined based on a channel arrangement of WLAN defined in IEEE 802.11 which is a communication standard of Wi-Fi (registered trademark).

The reception-side display unit 25 is configured by, for example, a liquid crystal display (LCD), an organic electroluminescence display (OLED), or the like, and, under control of the reception-side control unit 26 based on a command from the management-side control unit 33 (described below) of the management device 4, displays setting contents of the management-side operation unit 31 or setting contents by the reception-side operation unit 24, a signal waveform at the output point P3 in FIG. 1, measurement results, and the like.

The reception-side control unit 26 integrally controls the reception-side level adjustment unit 21, the reception-side frequency conversion unit 22, the measurement unit 23, the reception-side operation unit 24, and the reception-side display unit 25 based on setting contents of the management-side operation unit 31 or setting contents of the reception-side operation unit 24.

The management device 4 integrally controls the signal generator 2 and the signal analyzer 3 in order to perform desired measurement including error vector magnitude (EVM) measurement of the device under test W, and includes a management-side operation unit 31, a management-side display unit 32, and a management-side control unit 33.

The management-side operation unit 31 combines functions of the transmission-side operation unit 14 of the signal generator 2 and the reception-side operation unit 24 of the signal analyzer 3, and, under control of the management-side control unit 33, performs instructions to start or stop measurement of the device under test W by the wireless measurement apparatus 1, settings of a frequency or an output level of the signal generated by the waveform generation unit 11, settings of a frequency of the oscillator 12a of the transmission-side frequency conversion unit 12, settings of an output level of the signal of the transmission-side level adjustment unit 13, settings of an output level of the signal of the reception-side level adjustment unit 21, settings of a frequency of the oscillator 22a of the reception-side frequency conversion unit 22, and the like.

The management-side display unit 32 combines functions of the transmission-side display unit 15 of the signal generator 2 and the reception-side display unit 25 of the signal analyzer 3, is configured by, for example, a liquid crystal display (LCD), an organic electroluminescence display (OLED), or the like, and, under control of the management-side control unit 33, displays setting contents by the management-side operation unit 31, the transmission-side operation unit 14, and the reception-side operation unit 24, signal waveforms at respective points P1, P2, and P3 in FIG. 1, measurement results, and the like.

The management-side control unit 33 outputs a command to the signal generator 2 or the signal analyzer 3 based on setting contents of the management-side operation unit 31, and integrally controls the signal generator 2, the signal analyzer 3, the management-side operation unit 31, and the management-side display unit 32.

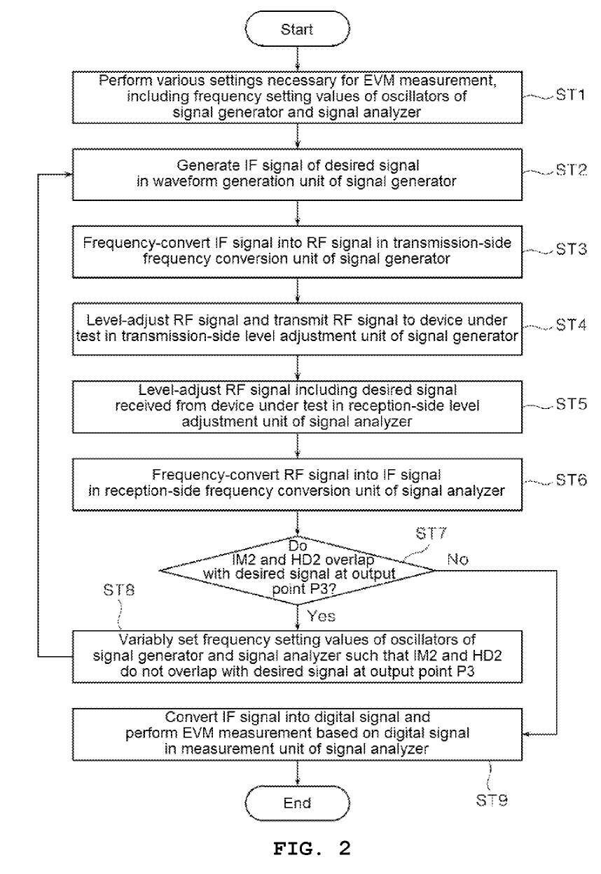

Next, an operation in a case of performing EVM measurement of the device under test W using the wireless measurement apparatus 1 configured as described above will be described with reference to a flowchart of FIG. 2. Note that the following operation is executed by the management device 4 integrally controlling the signal generator 2 and the signal analyzer 3.

By operation of the management-side operation unit 31 of the management device 4 (or operation of the transmission-side operation unit 14 of the signal generator 2 or the reception-side operation unit 24 of the signal analyzer 3), various settings necessary for EVM measurement of the device under test W are performed, including frequency setting values of the oscillator 12a of the transmission-side frequency conversion unit 12 of the signal generator 2 and the oscillator 22a of the reception-side frequency conversion unit 22 of the signal analyzer 3 (ST1).

When the various settings necessary for EVM measurement of the device under test W are performed, in the waveform generation unit 11 of the signal generator 2, an IF signal of a desired signal DA-converted into an analog signal by a DA converter is generated (ST2).

Next, in the transmission-side frequency conversion unit 12 of the signal generator 2, the IF signal generated by the waveform generation unit 11 is frequency-converted into an RF signal (ST3).

Subsequently, in the transmission-side level adjustment unit 13 of the signal generator 2, the RF signal frequency-converted by the transmission-side frequency conversion unit 12 is level-adjusted, and the level-adjusted RF signal is transmitted to the device under test W (ST4).

Then, when the level-adjusted RF signal is transmitted from the signal generator 2 to the device under test W, in the reception-side level adjustment unit 21 of the signal analyzer 3, level adjustment of the RF signal including the desired signal received from the device under test W is performed (ST5).

Next, in the reception-side frequency conversion unit 22 of the signal analyzer 3, the RF signal level-adjusted by the reception-side level adjustment unit 21 is frequency-converted into an IF signal (ST6).

Subsequently, in the reception-side control unit 26 of the signal analyzer 3, it is determined whether or not IM2 and HD2 serving as unwanted waves overlap with the desired signal of the frequency-converted IF signal at the output point P3 of the reception-side frequency conversion unit 22 in FIG. 1 (ST7).

Then, when it is determined that IM2 and HD2 overlap with the desired signal of the frequency-converted IF signal at the output point P3 of the reception-side frequency conversion unit 22 in FIG. 1 (ST7-Yes), frequency setting values of the oscillator 12a of the transmission-side frequency conversion unit 12 of the signal generator 2 and the oscillator 22a of the reception-side frequency conversion unit 22 of the signal analyzer 3 are variably set such that IM2 and HD2 do not overlap with the desired signal at the output point P3 (ST8), and the process returns to the process of ST2.

On the other hand, when it is determined that IM2 and HD2 do not overlap with the desired signal of the frequency-converted IF signal at the output point P3 of the reception-side frequency conversion unit 22 in FIG. 1 (ST7-No), in the measurement unit 23 of the signal analyzer 3, the IF signal is converted into a digital signal, and EVM measurement of the device under test W is performed based on the converted digital signal (ST9).

Here, specific numerical examples will be described regarding a state before improvement where IM2 and HD2 overlap with the desired signal at the output point P3 of the reception-side frequency conversion unit 22 in FIG. 1 in ST7 of the operation described above.

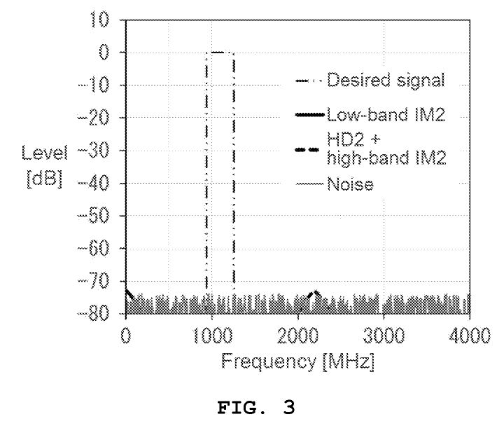

Before improvement, the frequency setting value of the oscillator 12a of the transmission-side frequency conversion unit 12 of the signal generator 2 is set to 8000 MHz, and the frequency setting value of the oscillator 22a of the reception-side frequency conversion unit 22 of the signal analyzer 3 is set to 7600 MHz. In this case, regarding a signal waveform at the output point P1 of the waveform generation unit 11 of the signal generator 2 in FIG. 1, as shown in FIG. 3, a low-level IM2 (low-band IM2) indicated by a thick solid line appears at a position (around 0 MHz) lower in frequency than a desired signal (center frequency: 1095 MHz, bandwidth: 320 MHz) indicated by a two-dot chain line without overlapping with the desired signal, and low-level HD2 and IM2 (HD2 + high-band IM2) indicated by a thick broken line appear at a position (around 2190 MHz) higher in frequency than the desired signal indicated by the two-dot chain line without overlapping with the desired signal.

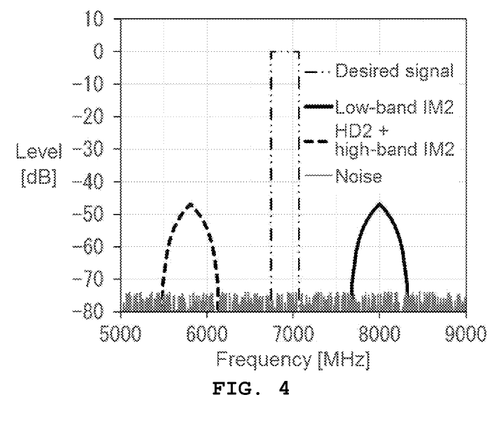

On the other hand, regarding a signal waveform at the output point P2 of the transmission-side frequency conversion unit 12 of the signal generator 2 in FIG. 1, as shown in FIG. 4, the frequency relationship is reversed from that in FIG. 3, and IM2 (low-band IM2) indicated by a thick solid line appears at a position (around 8000 MHz) higher in frequency than the desired signal (center frequency: 6905 MHz, bandwidth: 320 MHz) indicated by a two-dot chain line without overlapping with the desired signal, and HD2 and IM2 (HD2 + high-band IM2) indicated by a thick broken line appear at a position (around 5800 MHz) lower in frequency than the desired signal indicated by the two-dot chain line without overlapping with the desired signal.

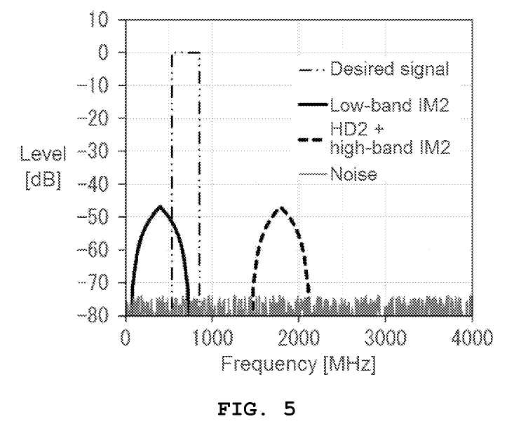

Then, regarding a signal waveform at the output point P3 of the reception-side frequency conversion unit 22 of the signal analyzer 3 in FIG. 1, as shown in FIG. 5, HD2 and IM2 (HD2 + high-band IM2) indicated by a thick broken line appear at a position (around 1800 MHz) higher in frequency than the desired signal (center frequency: 695 MHz, bandwidth: 320 MHz) indicated by a two-dot chain line without overlapping with the desired signal; however, a part of IM2 (low-band IM2) indicated by a thick solid line appears at a position (around 400 MHz) lower in frequency than the desired signal indicated by the two-dot chain line while overlapping with the desired signal, serving as an inhibition factor of EVM < -53 dB.

Therefore, after improvement in the present embodiment, in order for IM2 and HD2 not to overlap with the desired signal at the output point P3 of the reception-side frequency conversion unit 22 of the signal analyzer 3 in FIG. 1, the frequency setting value of the oscillator 12a of the transmission-side frequency conversion unit 12 of the signal generator 2 or the frequency setting value of the oscillator 22a of the reception-side frequency conversion unit 22 of the signal analyzer 3 is variably set based on the channel arrangement of WLAN defined in IEEE 802.11 which is the communication standard of Wi-Fi (registered trademark).

Specific numerical values will be shown. The frequency setting value of the oscillator 12a of the transmission-side frequency conversion unit 12 of the signal generator 2 is set to 8000 MHz, which is the same as before improvement, but the frequency setting value of the oscillator 22a of the reception-side frequency conversion unit 22 of the signal analyzer 3 is variably set from 7600 MHz before improvement to 6000 MHz.

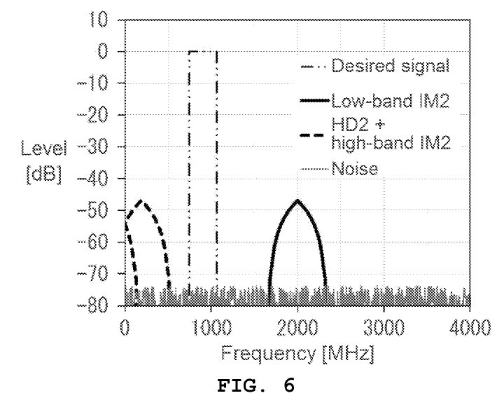

Consequently, regarding the signal waveform at the output point P3 of the reception-side frequency conversion unit 22 of the signal analyzer 3 in FIG. 1, as shown in FIG. 6, IM2 (low-band IM2) indicated by a thick solid line appears at a position (around 2000 MHz) higher in frequency than the desired signal (center frequency: 905 MHz, bandwidth: 320 MHz) indicated by a two-dot chain line without overlapping with the desired signal, and HD2 and IM2 (HD2 + high-band IM2) indicated by a thick broken line appear at a position (around 200 MHz) lower in frequency than the desired signal indicated by the two-dot chain line without overlapping with the desired signal. That is, it is possible to suppress deterioration of error vector magnitude (EVM) by shifting IM2 and HD2 generated in the signal generator 2 on the transmission side to out-of-band of the desired signal in the signal analyzer 3 on the reception side. As a result, desired reception-side error vector magnitude (reception-side EVM) performance (performance of -53 dB or less) can be obtained.

Incidentally, in the above-described embodiment, the transmission-side operation unit 14 and the transmission-side display unit 15 of the signal generator 2, the reception-side operation unit 24 and the reception-side display unit 25 of the signal analyzer 3, and the management-side operation unit 31 and the management-side display unit 32 of the management device 4 are illustrated in FIG. 1 as separate blocks, respectively, but these units may be configured as an operation display unit in which the operation unit and the display unit are integrated, for example, a touch panel.

In addition, in FIG. 1, the signal generator 2 and the signal analyzer 3 are illustrated as separate blocks, but the signal generator 2 and the signal analyzer 3 can be configured in a single housing or as separate modules.

Further, in FIG. 1, the management-side control unit 33 of the management device 4 integrally controls the signal generator 2 and the signal analyzer 3, the transmission-side control unit 16 controls respective units of the signal generator 2, and the reception-side control unit 26 controls respective units of the signal analyzer 3, but the present invention is not limited to the configuration of FIG. 1.

For example, a configuration may be employed in which the management device 4 is omitted from FIG. 1, and the signal generator 2 and the signal analyzer 3 may be individually controlled. That is, without intervention of the management device 4, the transmission-side control unit 16 controls respective units of the signal generator 2, and the reception-side control unit 26 controls respective units of the signal analyzer 3.

In addition, in FIG. 1, the signal generator 2, the signal analyzer 3, and the management device 4 individually include operation units (the transmission-side operation unit 14, the reception-side operation unit 24, and the management-side operation unit 31) and display units (the transmission-side display unit 15, the reception-side display unit 25, and the management-side display unit 32), respectively; however, the transmission-side operation unit 14 and the transmission-side display unit 15 of the signal generator 2, and the reception-side operation unit 24 and the reception-side display unit 25 of the signal analyzer 3 can be omitted. In this case, the management-side operation unit 31 and the management-side display unit 32 of the management device 4 serve as functions of the operation units (the transmission-side operation unit 14 and the reception-side operation unit 24) and the display units (the transmission-side display unit 15 and the reception-side display unit 25) of the signal generator 2 and the signal analyzer 3.

As described above, according to the present embodiment, in performing EVM measurement by transmitting a signal generated by the signal generator to the device under test and receiving a signal from the device under test by the signal analyzer in association with this transmission, a simple configuration is employed in which the signal generator includes a one-stage up-conversion frequency conversion unit and the signal analyzer includes a one-stage down-conversion frequency conversion unit. By variably setting (changing settings of) frequency setting values of oscillators of the respective frequency conversion units based on a channel arrangement of WLAN defined in the communication standard, converting an IF signal into an RF signal by one-time frequency conversion on each of the transmission side and the reception side to transmit the RF signal to the device under test, and then converting the RF signal received from the device under test into an IF signal, it is possible to prevent in-band emission from deteriorating by shifting IM2 and HD2 serving as unwanted waves generated on the transmission side to out-of-band of the desired signal on the reception side. As a result, desired reception-side error vector magnitude (reception-side EVM) performance (performance of -53 dB or less) can be obtained.

The best mode of the wireless measurement apparatus and the wireless measurement method according to the present invention has been described above, but the present invention is not limited by the description and the drawings according to this mode. That is, it goes without saying that other modes, examples, operation techniques, and the like made by those skilled in the art based on this mode are all included in the scope of the present invention.

### DESCRIPTION OF REFERENCE NUMERALS AND SIGNS

1 Wireless measurement apparatus
2 Signal generator (transmitter)
3 Signal analyzer (receiver)
4 Management device
11 Waveform generation unit
12 Transmission-side frequency conversion unit (first frequency conversion unit)
12a Oscillator
12b Mixer
13 Transmission-side level adjustment unit
14 Transmission-side operation unit
15 Transmission-side display unit
16 Transmission-side control unit
21 Reception-side level adjustment unit
22 Reception-side frequency conversion unit (second frequency conversion unit)
22a Oscillator
22b Mixer
23 Measurement unit
24 Reception-side operation unit
25 Reception-side display unit
26 Reception-side control unit
31 Management-side operation unit
32 Management-side display unit
33 Management-side control unit
W Device under test
P1 Output point of waveform generation unit
P2 Output point of transmission-side frequency conversion unit
P3 Output point of reception-side frequency conversion unit

What is claimed is:

1. A wireless measurement apparatus comprising:
a signal generator including a first frequency conversion unit; and
a signal analyzer including a second frequency conversion unit,
wherein the wireless measurement apparatus transmits a signal generated by the signal generator to a device under test, and receives and measures a signal from the device under test by the signal analyzer in association with the transmission, and
the first frequency conversion unit and the second frequency conversion unit change a frequency setting value of at least one of the first frequency conversion unit and the second frequency conversion unit such that, at an output point of the second frequency conversion unit, a frequency component of the signal from the device under test does not overlap with intermodulation 2 (IM2) or harmonic distortion 2 (HD2).

2. The wireless measurement apparatus according to claim 1,
wherein the first frequency conversion unit performs up-conversion, and
the second frequency conversion unit performs down-conversion.

3. The wireless measurement apparatus according to claim 1,
wherein the frequency setting value is changed based on a channel arrangement of WLAN defined in IEEE 802.11.

4. A wireless measurement method using a wireless measurement apparatus including a signal generator including a first frequency conversion unit and a signal analyzer including a second frequency conversion unit, the wireless measurement method comprising:
a step of changing frequency setting values of the first frequency conversion unit and the second frequency conversion unit such that, at an output point of the second frequency conversion unit, a frequency component of a signal from a device under test does not overlap with intermodulation 2 (IM2) or harmonic distortion 2 (HD2).

5. The wireless measurement method according to claim 4,
wherein the first frequency conversion unit performs up-conversion, and
the second frequency conversion unit performs down-conversion.

6. The wireless measurement method according to claim 4,
wherein the frequency setting values are changed based on a channel arrangement of WLAN defined in IEEE 802.11.
